(19) United States
(12) Patent Application Publication
(10) Pub. No.: US 2007/0294950 A1
(43) Pub. Date: Dec. 27, 2007

(54) Vehicle Window Mounting Assembly

(75) Inventors: Randy C. Allen, Rochester, MI (US); David T. Renke, Macomb, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., Detroit, MI (US)

(21) Appl. No.: 11/425,424

(22) Filed: Jun. 21, 2006

(51) Int. Cl. E05F 11/38

(52) U.S. Cl. 49/375; 49/502; 49/440

(57) ABSTRACT

The invention concerns a window assembly in a vehicle having a window pane that is fixed in a window frame that is also used for movable windows. The window assembly may have a window mounting bracket assembly including a support plate mounted to the vehicle structure; a window support cam mounted to the support plate and pivotable about a cam axis, the window support cam having a lobe portion extending away from the cam axis and a peripheral window support surface for receiving and supporting a lower edge of the window pane; and a cam lock operatively engaging the window support cam to selectively prevent the window support cam from rotating relative to the support plate. The invention also concerns a method of mounting the fixed window pane in the vehicle window assembly.

### BACKGROUND OF INVENTION

The present invention relates generally to a window in a vehicle, and in particular to a mounting assembly for a vehicle window.

For some automotive vehicles, customers are offered an option—for certain windows on the vehicle—to have fixed glass or a window that can open. The windows that can open typically have a window pane that slides in guide channels between inner and outer portions of a seal in a window opening. The opening and closing motion may be driven by a hand crank, a so-called manually opening window, or by a motor, a so-called power window. For the fixed glass configuration, the window pane is typically bonded in place over the window opening with urethane and encapsulated with a rubber weatherstrip surround.

The look of the window for a fixed glass window, then, is different from the look of the window in the same vehicle when a moving window option is chosen. Moreover, the shape of the window pane is different for the two, requiring two different shaped pieces of glass, one for each type of construction. This also requires a different door/vehicle body construction for fixed and moving glass systems. Thus, the application of two different mounting techniques for fixed and moving window options in a particular vehicle is undesirable, since it does not allow a particular vehicle to have a common appearance for the different window options, and it requires a different construction for the window pane and structure.

In order to overcome these drawbacks, some have employed a window pane and door construction for a movable window—whether or not the window pane is meant to be fixed. For the movable window configurations, the usual manual or power window mechanisms (also called regulators) are employed. For a fixed window, most of the manual window mechanism is installed. The window pane is also installed and mounted to the manual window mechanism. Then, the mechanism is used once at the assembly plant to move the window pane into the full up (closed) position, and is locked in this position. No window crank handle is put on the inside of the door so it can never be rolled down. This gives the customer a fixed glass window while maintaining the same look of vehicles whether they have a fixed window, manually opening, or a power opening window. Moreover, the same window pane and essentially the same door construction can be employed for all of the configurations. However, this one time use of the manual regulator assembly includes most of the components necessary for a manually opening window, such as a cable system, clutch drive mechanism, long rails for guiding the window to its full up and down positions, etc. So this configuration adds significantly to the weight, number of parts, complexity and cost of the more conventional fixed window.

### SUMMARY OF INVENTION

An embodiment contemplates a window assembly in a vehicle having a window pane fixably secured in a window frame defining a window opening. The window assembly comprises a vehicle structure adjacent to the window opening; a pair of run channels supported by the vehicle structure; a sealing assembly mounted in the run channels and including an inner portion and an outer portion forming a gap for slidably receiving the window pane therein; and a window mounting bracket assembly including a support plate mounted to the vehicle structure, a window support cam mounted to the support plate and pivotable about a cam axis, the window support cam having a lobe portion extending away from the cam axis and a peripheral window support surface for receiving and supporting a lower edge of the window pane, and a cam lock operatively engaging the window support cam to selectively prevent the window support cam from rotating relative to the support plate.

An embodiment contemplates a window mounting bracket assembly for mounting a window pane between an inner and an outer portion of a window sealing assembly of a window opening in a vehicle. The assembly may include a support plate adapted to be mounted to a vehicle structure, and a window support cam mounted to the support plate and pivotable about a cam axis. The window support cam may have a lobe portion extending away from the cam axis and a peripheral window support surface for receiving and supporting a lower edge of the window pane. A cam lock may operatively engage with the window support cam to selectively prevent the window support cam from rotating relative to the support plate.

An embodiment contemplates a method of fixedly mounting a window pane in a window opening of a vehicle window frame, the method comprising the steps of: mounting a window mounting bracket assembly to a vehicle structure adjacent to the window opening; sliding the window pane into run channels of the vehicle window frame; mounting a lower edge of the window pane onto a peripheral support surface of a window support cam of the window mounting bracket assembly; rotating a cam lobe of the window support cam into contact with the lower edge of the window pane until the window pane is lifted into a fully closed position; and locking the window support cam against rotation after the window pane is lifted into the fully closed position.

An advantage of an embodiment is that the window mounting bracket assembly allows for the use of the same window pane and same sealing assembly for both opening and fixed windows, while not incurring the unneeded extra expense, parts, assembly time and weight of a manual window regulator for a fixed window.

An advantage of an embodiment is that, while the window pane acts as a fixed window (in a fixed window application), the window mounting bracket assembly still allows for variation in build tolerances and adjustment of the window pane, should servicing needs require this.

### BRIEF DESCRIPTION OF DRAWINGS

FIG. 1 is a partially schematic perspective view of a portion of a vehicle window assembly.

FIG. 2 is a section cut, on an enlarged scale, taken along line 2-2 in FIG. 1, but without the run channel shown.

FIG. 3 is a schematic elevation view of a portion of a door and window assembly.

FIG. 4 is a schematic, side view of a window mounting bracket assembly.

FIG. 5 is a schematic elevation view of the window mounting bracket assembly.

FIG. 6 is a schematic elevation view of a portion of a door frame.

FIG. 7 is a schematic elevation view of a bracket support plate and fasteners.

### DETAILED DESCRIPTION

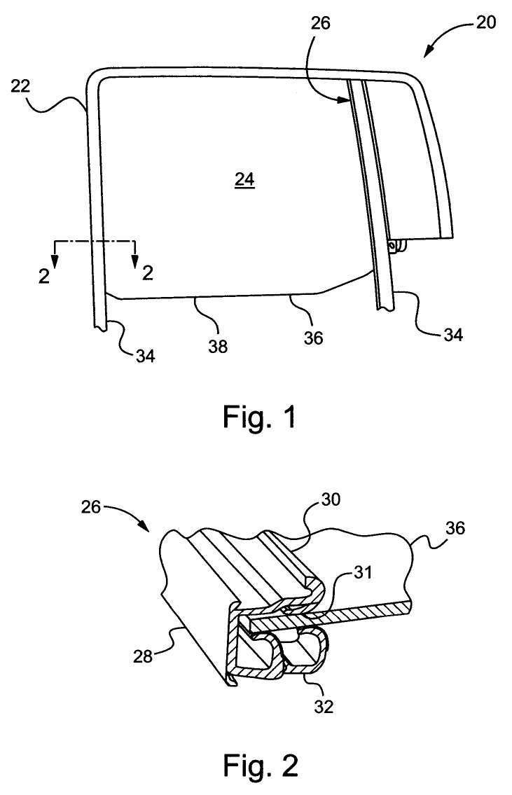

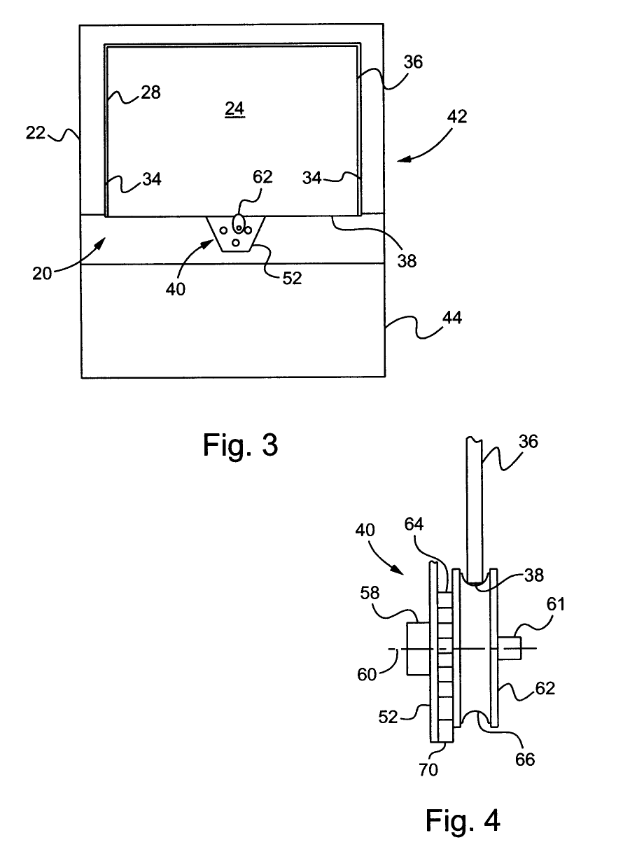

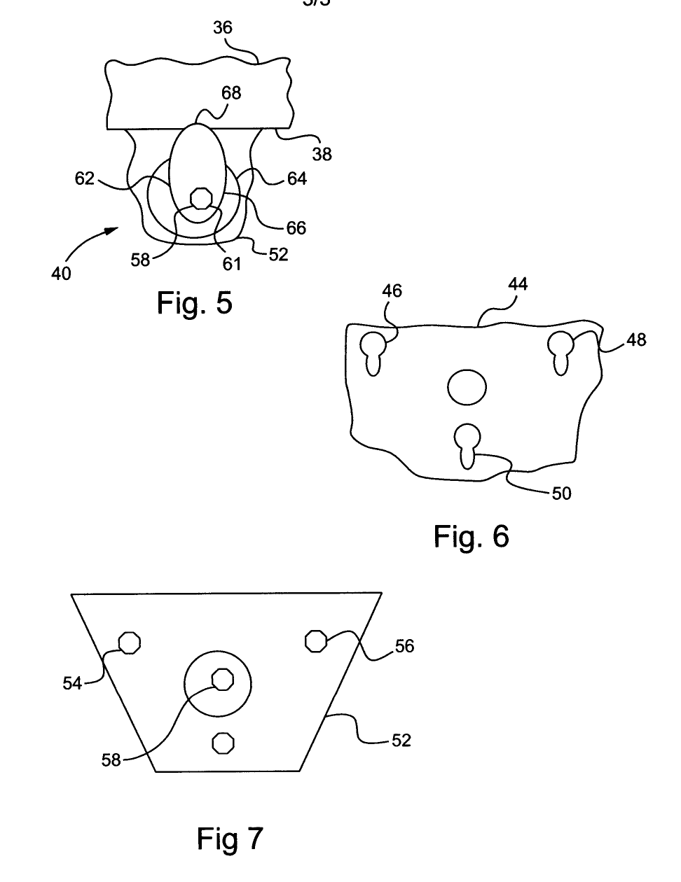

FIGS. 1 and 2 illustrate a vehicle window assembly, indicated generally at 20, that includes a window frame 22 defining a window opening 24. Extending along the window frame 22 around the window opening 24 is a sealing assembly 26. The sealing assembly 26 includes a window seal 28 (also called a weatherstrip) having an inner portion 30 facing into the vehicle and an outer portion 32 facing outward from the vehicle, with a gap 31 defined between them. The window frame 22 also includes window run channels 34, within which portions of the sealing assembly 26 are mounted. The window run channels 34 retain and guide a window pane 36 in the gap 31, while allowing the window pane 36 to slide up and down. The vehicle window assembly 20 illustrated in FIGS. 1 and 2 allows for use of the conventional manual and power window regulators as well as a window mounting bracket assembly 40, which will be discussed relative to FIGS. 3-7.

FIGS. 3-7 illustrate the vehicle window assembly 20 as part of a vehicle door assembly, indicated generally at 42. While this embodiment illustrates a window frame 22 defining a window opening 24 in the door assembly 42, the present invention can be employed anywhere on a vehicle where there is an option between a fixed window and a moving window, such as, for example a rear door on an extended cab pickup, a van sliding door, or a back light of a pickup truck.

A door frame 44 of the door assembly 42 includes three slotted mounting holes 46 located below the window opening 24. Each slotted mounting hole 46 may include a larger diameter upper portion 48 and a smaller diameter lower portion 50. Although three holes 46 are shown in this embodiment, other numbers may be employed instead, if so desired.

The window mounting bracket assembly 40 includes a bracket support plate 52, having three mounting fasteners 54 extending therefrom and located so that each one aligns with a respective one of the slotted mounting holes 46. Each mounting fastener 54 includes a head 56 that is small enough to be received through a respective one of the upper portions 48, but is large enough that it cannot slide through the corresponding lower portion 50. While fasteners and holes are illustrated as a means for mounting the support plate to vehicle structure, other means of mounting may be employed instead, if so desired.

A cam shaft 58 extends through the bracket support plate 52 and is centered about a cam axis 60. The cam shaft 58 also includes a cam rotation feature 61.

A window support cam 62 is mounted on the cam shaft 58 and is spaced from the bracket support plate 52 by a spacer 64. The window support cam 62 includes a peripheral support surface 66 for supporting a lower edge 38 of the window pane 36. The shape of the peripheral support surface 66 may be a semi-cylindrical concave surface for receiving and centering the window pane 36 relative to the window support cam 62. This surface may have a different shape, if so desired. The window support cam 62 includes a cam lobe 68, where the peripheral support surface 66 extends farther from the cam axis 60 than at other locations along the peripheral support surface 66.

The window mounting bracket assembly 40 also includes a cam lock 70. The cam lock 70 can be inserted between the bracket support plate 52 and the window support cam 62 to lock the two together so they cannot rotate relative to each other. With the cam lock 70 removed, the window support cam 62 can rotate relative to the bracket support plate 52, particularly when driven by the cam rotation feature 61.

The installation procedure for installing a fixed window configuration with the window mounting bracket assembly 40 will now be discussed. The window mounting bracket assembly 40 is assembled. The bracket support plate 52 is attached to the door frame 44 (which may be a door inner panel) by mounting the heads 56 of the mounting fasteners 54 in the upper portions 48 of the three slotted mounting holes 46 and sliding the plate 52 down. The heads 56 are now trapped in the lower portions 50 of the holes 46.

The window pane 36 is then loaded into the window frame 22 by sliding it up in the window run channels 34 between the inner and outer portions 30, 32 of the window seal 28. The lower edge 38 of the window pane 36 is mounted in the peripheral support surface 66 of the window support cam 62 while the support cam 62 is oriented so that it is at or near its lowest position (i.e., the cam lobe 68 is not extending upward). Then, the window support cam 62 is rotated (using the cam rotation feature 61, if desired) to rotate the cam lobe 68 upward, thus pushing the window pane 36 into its full up (closed) position. The cam lock 70 is then inserted into the mounting bracket assembly 40 to lock the support cam 62 in position and thus lock the window pane 36 permanently in the fully closed position. This also holds the mounting fasteners 54 in the lower portion 50 of the slofted mounting holes 46 so the heads 56 cannot slide out of the upper portions 48 of the mounting holes 46.

While certain embodiments of the present invention have been described in detail, those familiar with the art to which this invention relates will recognize various alternative designs and embodiments for practicing the invention as defined by the following claims.

What is claimed is:

1. A window mounting bracket assembly for mounting a window pane between an inner and an outer portion of a window sealing assembly of a window opening in a vehicle, the assembly comprising:
a support plate adapted to be mounted to a vehicle structure;
a window support cam mounted to the support plate and pivotable about a cam axis, the window support cam having a lobe portion extending away from the cam axis and a peripheral window support surface for receiving and supporting a lower edge of the window pane; and
a cam lock operatively engageable with the window support cam to selectively prevent the window support cam from rotating relative to the support plate.

2. The window mounting bracket assembly of claim 1 wherein the vehicle structure is a door frame.

3. The window mounting bracket assembly of claim 1 including a cam rotation feature operatively engaging the window support cam and adapted to provide leverage to assure the window support cam rotates to push the window pane into a full up position.

4. The window mounting bracket assembly of claim 1 wherein the peripheral window support surface is a semi-cylindrical concave surface adapted to receive and center the window pane relative to the window support cam.

5. The window mounting bracket assembly of claim 1 including a spacer mounted between the support plate and the window support cam.

6. The window mounting bracket assembly of claim 5 wherein the cam lock is mounted between the support plate and the window support cam adjacent to the spacer.

7. The window mounting bracket assembly of claim 1 wherein the support plate includes a plurality of fasteners secured to the support plate and adapted to be secured to a plurality of holes in the vehicle structure.

8. A window assembly in a vehicle having a window pane fixably secured in a window frame defining a window opening, the window assembly comprising:
a vehicle structure adjacent to the window opening;
a pair of run channels supported by the vehicle structure;
a sealing assembly mounted in the run channels and including an inner portion and an outer portion forming a gap for slidably receiving the window pane therein; and
a window mounting bracket assembly including a support plate mounted to the vehicle structure; a window support cam mounted to the support plate and pivotable about a cam axis, the window support cam having a lobe portion extending away from the cam axis and a peripheral window support surface for receiving and supporting a lower edge of the window pane; and a cam lock operatively engaging the window support cam to selectively prevent the window support cam from rotating relative to the support plate.

9. The window assembly of claim 8 wherein the vehicle structure includes a plurality of mounting holes located below the window opening and the support plate includes a plurality of fasteners secured thereto, with each of the fasteners secured in a respective one of the mounting holes in the vehicle structure.

10. The window assembly of claim 8 wherein the vehicle structure is a door frame.

11. The window assembly of claim 8 wherein the window bracket mounting assembly includes a cam rotation feature operatively engaging the window support cam and adapted to provide leverage to assure the window support cam rotates to push the window pane into a full up position.

12. The window assembly of claim 8 wherein the peripheral window support surface is a semi-cylindrical concave surface adapted to receive and center the window pane relative to the window support cam.

13. The window assembly of claim 8 wherein the window bracket mounting assembly includes a spacer mounted between the support plate and the window support cam.

14. The window assembly of claim 13 wherein the cam lock is mounted between the support plate and the window support cam, adjacent to the spacer.

15. A method of fixedly mounting a window pane in a window opening of a vehicle window frame, the method comprising the steps of:
(a) mounting a window mounting bracket assembly to a vehicle structure adjacent to the window opening;
(b) sliding the window pane into run channels of the vehicle window frame;
(c) mounting a lower edge of the window pane onto a peripheral support surface of a window support cam of the window mounting bracket assembly;
(d) rotating a cam lobe of the window support cam into contact with the lower edge of the window pane until the window pane is lifted into a fully closed position; and
(e) locking the window support cam against rotation after the window pane is lifted into the fully closed position.

16. The method of claim 15 wherein step (a) is further defined by the vehicle structure being a door frame.

17. The method of claim 15 wherein step (a) is further defined by:
providing a plurality of slotted mounting holes located below the window opening, each of the slotted mounting holes having an upper portion and a lower portion that is narrower than the upper portion;
providing a plurality of fasteners extending from the window mounting bracket assembly, each of the fasteners including a head;
inserting each of the heads through a respective one of the upper portions of the slotted mounting holes; and
moving the window bracket mounting assembly downward to secure the heads in the lower portions of the slotted mounting holes.

18. The method of claim 15 wherein step (c) is further defined by the peripheral support surface being a semi-cylindrical concave surface, and the peripheral support surface receiving and centering the window pane relative to the window support cam when the lower edge of the window pane is mounted thereon.

19. The method of claim 15 wherein step (e) is further defined by inserting a cam lock between a bracket support plate secured to the vehicle structure and the window support cam to prevent rotation of the window support cam relative to the bracket support plate.

20. The method of claim 15 wherein step (b) is further defined by a window seal assembly being mounted in the run channels and defining a gap in the window seal assembly, and sliding the window pane into the gap.
